(19) United States
(12) Patent Application Publication
(10) Pub. No.: US 2026/0019513 A1
(43) Pub. Date: Jan. 15, 2026

(54) IMAGE FORMING APPARATUS

(71) Applicant: CANON KABUSHIKI KAISHA, Tokyo (JP)

(72) Inventor: SHOZO YAMASAKI, Tokyo (JP)

(21) Appl. No.: 19/256,609

(22) Filed: Jul. 1, 2025

(30) Foreign Application Priority Data
Jul. 12, 2024 (JP) 2024-112959

(51) Int. Cl. H04N 1/00

(52) U.S. Cl. CPC H04N 1/00496; H04N 1/00411; H04N 1/00432; H04N 1/00474

(57) ABSTRACT

An image forming apparatus includes an apparatus main body including an image forming unit for forming an image on a recording medium, and an operation unit including a display unit for displaying information about the image formation, and receiving a touch operation from a user. The operation unit is movable between a first position where the entire display unit is exposed to an outside of the apparatus main body, and a second position where at least a part of the display unit is retracted within the apparatus main body to reduce visibility of at least a part of the display unit. In a case where the operation unit is at the second position, the display unit prompts the user to pull the operation unit from the apparatus main body.

### BACKGROUND

### Field of the Technology

The present disclosure relates to an image forming apparatus including an operation panel.

### Description of the Related Art

Image forming apparatuses that form images on recording media generally include an operation unit including a display used to show information on progress status of an image forming operation, various setting details, and the like. The above-described operation unit may reduce visibility of a discharge area for recording media, depending on the size and the installation position of the operation unit. Japanese Patent Application No. 2019-176434 discusses a configuration in which a part of the operation unit including a touch panel is stored in a storage portion provided in the apparatus main body, and the operation unit is movable to provide the visibility of the discharge area.

### SUMMARY

The present disclosure is directed to a technique for improving user operability of an image forming apparatus including an operation unit retractable into a storage portion.

An aspect of the present disclosure provides an image forming apparatus that includes an apparatus main body including an image forming unit configured to form an image on a recording medium, and an operation unit including a display unit configured to display information about the image formation. The display unit is configured to receive a touch operation from a user. The operation unit is movable between a first position where the entire display unit is exposed to an outside of the apparatus main body, and a second position where at least a part of the display unit is retracted within the apparatus main body to reduce visibility of at least a part of the display unit from the outside of the apparatus main body. In a case where the operation unit is at the second position, the display unit is configured to prompt the user to pull the operation unit from the apparatus main body.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram of an image forming apparatus according to an exemplary embodiment.

FIG. 2 is a perspective view when an operation panel of the image forming apparatus is in a retracted state, according to the present exemplary embodiment.

FIG. 3 is a perspective view in a state where the operation panel of the image forming apparatus is in an exposed state and is not pivoted, according to the present exemplary embodiment.

FIG. 4 is a perspective view in a state where the operation panel of the image forming apparatus is in the exposed state and is pivoted, according to the present exemplary embodiment.

FIG. 5 is a block diagram illustrating a configuration of components of an image forming system including the image forming apparatus, according to the present exemplary embodiment.

FIG. 6 is a block diagram illustrating a configuration of components of the operation panel of the image forming apparatus, according to the present exemplary embodiment.

FIGS. 7A to 7C are diagrams illustrating operations of the operation panel of the image forming apparatus, according to the present exemplary embodiment.

FIG. 8 is a flowchart of panel state detection processing performed by the image forming apparatus, according to the present exemplary embodiment.

FIG. 9 illustrates an example of a display of the operation panel of the image forming apparatus, according to the present exemplary embodiment.

FIG. 10 illustrates another example of the display of the operation panel of the image forming apparatus, according to the present exemplary embodiment.

FIG. 11 illustrates still another example of the display of the operation panel of the image forming apparatus according to the present exemplary embodiment.

FIG. 12 illustrates still another example of the display of the operation panel of the image forming apparatus, according to the present exemplary embodiment.

FIG. 13 illustrates still another example of the display of the operation panel of the image forming apparatus, according to the present exemplary embodiment.

### DESCRIPTION OF THE EMBODIMENTS

An exemplary embodiment will now be described in detail with reference to the drawings.

### Image Forming System

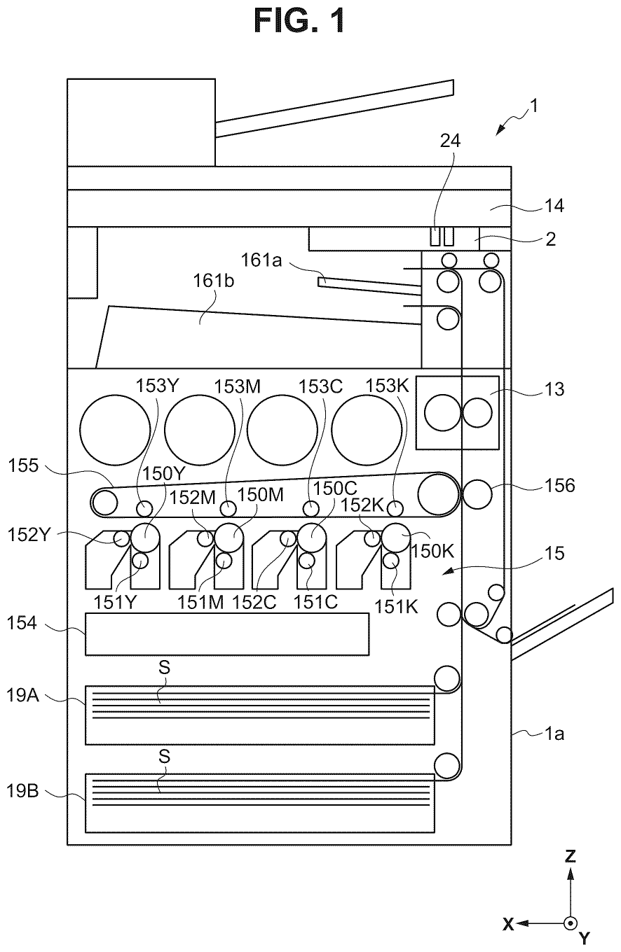

A configuration of an image forming system A according to a first exemplary embodiment will be described in detail with reference to FIGS. 1 to 5.

The image forming system A includes an image forming apparatus 1, a processing apparatus 16, and a notification apparatus 17. The image forming system A may not include the processing apparatus 16.

The image forming apparatus 1 forms an image on a sheet S as a recording medium, and conveys the sheet S with the image thereon to the processing apparatus 16, or discharges the sheet S with the image thereon to the outside. The image forming apparatus 1 discharges the sheet S conveyed from the processing apparatus 16 to the outside. Details of the image forming apparatus 1 are described herein.

The processing apparatus 16 is connected to the image forming apparatus 1 in order to optionally extend functionality thereof. The processing apparatus 16 performs processing set by a user, such as stapling, punching, and binding, on the sheet S with the image thereon, conveyed from the image forming apparatus 1. The processing apparatus 16 conveys the sheet S subjected to the processing set by the user to the image forming apparatus 1.

The notification apparatus 17 notifies a state of the image forming apparatus 1.

### Image Forming Apparatus

The configuration of the image forming apparatus 1 according to the present exemplary embodiment will be described in detail with reference to FIGS. 1 to 5, and FIGS. 7A to 7C.

The image forming apparatus 1 includes an apparatus main body la, an operation panel 2, a control unit 10, a storage device 11, a power supply device 12, a fixing unit 13, a reader 14, an image forming unit 15, a sheet cassette 19A, and a sheet cassette 19B. The image forming apparatus 1 also includes a first detection sensor 30, a second detection sensor 31, a discharge tray 161a, a discharge tray 161b, a shaft portion 62, and a light shielding member 71. The image forming apparatus 1 includes a rocker switch or a tactile switch as the main-body power supply switch for turning on and off the main power supply.

The apparatus main body la includes the fixing unit 13, the image forming unit 15, the sheet cassette 19A, and the sheet cassette 19B.

The operation panel 2 serving as an operation unit is extendable from/withdrawable into the apparatus main body la of the image forming apparatus 1, and the operation panel 2 is retractable into a space below the reader 14. The operation panel 2 is movable in a Y direction, i.e. along the Y axis, and is pivotable with respect to a pivot shaft parallel to an X direction, after being extended in the Y direction. The operation panel 2 is configured to be moved by the user, while remaining under the control of the control unit 10. Details of the configuration of the operation panel 2 will be described below.

The control unit 10 controls the entire operation of the image forming apparatus 1, and the operations of the processing apparatus 16 and the notification apparatus 17. The control unit 10 includes a central processing unit (CPU) 100, a memory 101, and a timer 102.

The CPU 100 controls the operations of the power supply device 12, the fixing unit 13, the reader 14, the image forming unit 15, the processing apparatus 16, and the notification apparatus 17, all of which are connected to the control unit 10. The CPU 100 reads and executes programs 110 stored in the storage device 11 to control the reader 14, the image forming unit 15, the processing apparatus 16, and the like using the memory 101. The CPU 100 performs image processing on image data input from the reader 14, stores the image data subjected to the image processing in the storage device 11, and transfers the image data subjected to the image processing to the image forming unit 15 to perform image forming processing of forming an image on the sheet S.

The CPU 100 outputs a control signal to the operation panel 2 for controlling the operation of the operation panel 2.

The CPU 100 reads display image data stored in the storage device 11 and output the display image data to the operation panel 2 to display the image on the operation panel 2.

The CPU 100 controls the operation of the image forming apparatus 1 based on a result of calculation of the coordinates of a touch position on a touch panel 22 (described below) of the operation panel 2, the touch position being indicated by electric signals input from the operation panel 2. The CPU 100 performs a mode switching operation (described below) for switching the image forming apparatus 1 from a standby mode to a sleep mode, i.e. a power-saving mode, with low power consumption based on a count value counted by the timer 102.

The CPU 100 performs panel state detection processing (described below) including determining a state of the operation panel 2 based on electric signals input from the first detection sensor 30 and the second detection sensor 31. The CPU 100 performs the panel state detection processing to output to the operation panel 2 an electric signal corresponding to the state of the operation panel 2. The CPU 100 performs retraction display unit control processing and/or exposure display unit control processing based on the state of the operation panel 2 determined by performing the panel state detection processing, and adjusts luminance of the display unit 21 of the operation panel 2, as described below.

The memory 101 temporarily stores data associated with execution of the programs 110 by the CPU 100.

The timer 102 performs timekeeping and counts count values under the control of the CPU 100 while the CPU 100 performs various kinds of processing.

The storage device 11 stores various programs 110 related to control of the image forming apparatus 1, display image data, print data, and the like. The various programs 110 stored in the storage device 11 are group(s) of software that allows the control unit 10 to perform various kinds of processing. The display image data stored in the storage device 11 is used to display images on the operation panel 2.

The power supply device 12 receives a supply of power from a power supply through an outlet plug. The power supply device 12 supplies power supplied from the power supply to each of the devices in the image forming system A under the control of the CPU 100.

The fixing unit 13 performs heating processing and pressurization processing on the sheet S with a toner image secondarily transferred thereon conveyed by an intermediate transfer belt 155 and a secondary transfer roller 156 to fix the toner image to the sheet S. The fixing unit 13 conveys the sheet S with the toner image thereon to the discharge tray 161a or the discharge tray 161b.

The reader 14 optically reads the image of a document placed on a glass platen, converts the image into image data, and outputs the converted image data to the image forming unit 15.

The image forming unit 15 performs the image forming processing of forming an image on the sheet S fed from the sheet cassette 19A or the sheet cassette 19B based on the image data input from the reader 14. The image forming unit 15 includes photosensitive drums 150Y, 150M, 150C, and 150K, charging devices 151Y, 151M, 151C, and 151K, and developing devices 152Y, 152M, 152C, and 152K. The image forming unit 15 includes primary transfer rollers 153Y, 153M, 153C, and 153K, a laser scanner unit 154, the intermediate transfer belt 155, and the secondary transfer roller 156.

The photosensitive drums 150Y, 150M, 150C, and 150K are rotated by driving a driving device. Toner images are formed on the photosensitive drums 150Y, 150M, 150C, and 150K using the charging devices 151Y, 151M, 151C, and 151K, the developing devices 152Y, 152M, 152C, and 152K, and the laser scanner unit 154.

The charging devices 151Y, 151M, 151C, and 151K respectively charge the surfaces of the photosensitive drums 150Y, 150M, 150C, and 150K.

The developing device 152Y applies yellow toner to an electrostatic latent image formed on the surface of the photosensitive drum 150Y by the laser scanner unit 154 to form a yellow toner image on the surface of the photosensitive drum 150Y.

The developing device 152M applies magenta toner to an electrostatic latent image formed on the surface of the photosensitive drum 150M by the laser scanner unit 154 to form a magenta toner image on the surface of the photosensitive drum 150M.

The developing device 152C applies cyan toner applies to an electrostatic latent image formed on the surface of the photosensitive drum 150C by the laser scanner unit 154 to form a cyan toner image on the surface of the photosensitive drum 150C.

The developing device 152K applies black toner to an electrostatic latent image formed on the surface of the photosensitive drum 150K by the laser scanner unit 154 to form a black toner image on the surface of the photosensitive drum 150K.

The primary transfer roller 153Y primarily transfers the yellow toner image formed on the surface of the photosensitive drum 150Y by the developing device 152Y to the intermediate transfer belt 151 with application of a primary transfer bias.

The primary transfer roller 153M primarily transfers the magenta toner image formed on the surface of the photosensitive drum 150M by the developing device 152M to the intermediate transfer belt 155 so as to superimpose the magenta toner image on the yellow toner image on the intermediate transfer belt 155 with application of a primary transfer bias.

The primary transfer roller 153C primarily transfers the cyan toner image formed on the surface of the photosensitive drum 150C by the developing device 152C to the intermediate transfer belt 155 with application of a primary transfer bias. At this time, the primary transfer roller 153C primarily transfers the cyan toner image so as to superimpose the cyan toner image on the yellow toner image and the magenta toner image on the intermediate transfer belt 155.

The primary transfer roller 153K primarily transfers the black toner image formed on the surface of the photosensitive drum 150K by the developing device 152K to the intermediate transfer belt 155 with application of a primary transfer bias. At this time, the primary transfer roller 153K primarily transfers the black toner image so as to superimpose the black toner image on the yellow toner image, the magenta toner image, and the cyan toner image on the intermediate transfer belt 155.

The image data output from the reader 14 or image data received from an external device via a network is input to the laser scanner unit 154. The laser scanner unit 154 emits laser beams to the surfaces of the photosensitive drums 150Y, 150M, 150C, and 150K charged by the charging devices 151Y, 151M, 151C, and 151K based on the input image data. The laser scanner unit 154 emits laser beams to the surfaces of the photosensitive drums 150Y, 150M, 150C, and 150K to form the electrostatic latent images on the surfaces of the photosensitive drums 150Y, 150M, 150C, and 150K.

The toner images are primarily transferred and superimposed by the primary transfer rollers 153Y, 153M, 153C, and 153K. As a result, a full-color toner image is formed on the intermediate transfer belt 155.

The secondary transfer roller 156 and the intermediate transfer belt 155 form a secondary transfer portion. The secondary transfer roller 156 secondarily transfers, at the secondary transfer portion, the full-color toner image on the intermediate transfer belt 155 to the sheet S fed from the sheet cassette 19A or the sheet cassette 19B with application of a secondary transfer bias. The secondary transfer roller 156 and the intermediate transfer belt 155 convey the sheet S with the full-color toner image secondarily transferred thereon to the fixing unit 13.

The sheet cassette 19A stores sheets S.

The sheet cassette 19B stores sheets S.

The first detection sensor 30 serving as a first detection sensor is a photosensor, such as a photo interrupter, disposed below the reader 14. The first detection sensor 30 includes a light emission unit that emits light, and a light reception unit that receives light emitted from the light emission unit. The first detection sensor 30 detects the light shielding member 71 that moves together with the operation panel 2 and the shaft portion 62, and outputs electric signals corresponding to detection results to the control unit 10.

The second detection sensor 31 is a photosensor, such as a photo interrupter, disposed below the reader 14. The second detection sensor 31 includes a light emission unit that emits light, and a light reception unit that receives light emitted from the light emission unit. The second detection sensor 31 is disposed at a different position from that of the first detection sensor 30 in the Y direction as a moving direction of the operation panel 2. The second detection sensor 31 detects the light shielding member 71 that moves together with the operation panel 2 and the shaft portion 62, and outputs electric signals corresponding to detection results to the control unit 10.

The operation panel 2 is connected to the shaft portion 62. The shaft portion 62 is moved together with the operation panel 2.

The light shielding member 71 is provided on the shaft portion 62. The light shielding member 71 is moved together with the shaft portion 62.

The sheet S with the toner image fixed thereto conveyed by the fixing unit 13 is discharged to the discharge tray 161a through the processing apparatus 16 or without passing through the processing apparatus 16.

The sheet S with the toner image fixed thereto conveyed by the fixing unit 13 is discharged to the discharge tray 161b through the processing apparatus 16 or without passing through the processing apparatus 16.

### Operation Panel

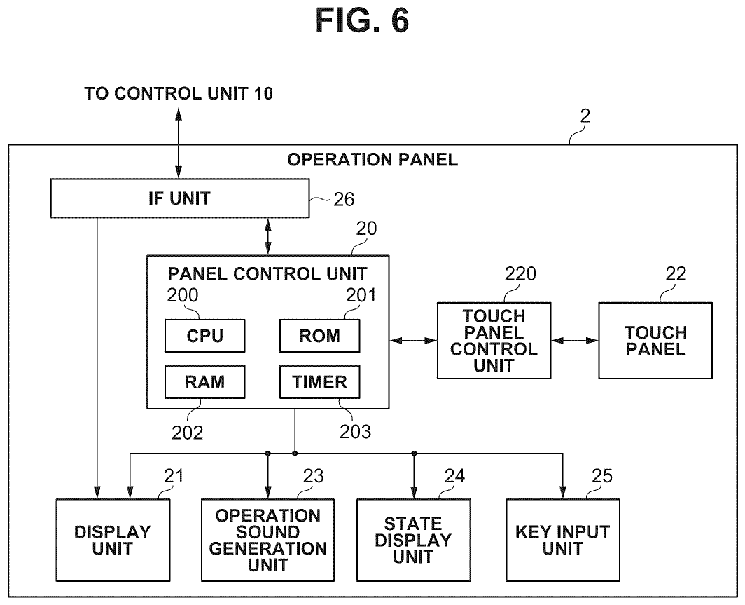

A configuration of the operation panel 2 of the image forming apparatus 1 according to the present exemplary embodiment will be described in detail with reference to FIGS. 1 to 6.

The operation panel 2 includes a panel control unit 20, the display unit 21, the touch panel 22, an operation sound generation unit 23, a state display unit 24, a key input unit 25, an interface (IF) unit 26, and a touch panel control unit 220.

The panel control unit 20 is connected to the control unit 10 via the IF unit 26, and generally controls the operation of the operation panel 2 under the control of the CPU 100. The panel control unit 20 includes a CPU 200, a read-only memory (ROM) 201, a random-access memory (RAM) 202, and a timer 203.

The CPU 200 serving as an output unit executes control programs stored in the ROM 201 based on control signals input from the CPU 100 via the IF unit 26 to perform various kinds of calculation processing. The CPU 200 executes the control programs to control the operations of the display unit 21, the operation sound generation unit 23, the state display unit 24, the key input unit 25, the IF unit 26, and the touch panel control unit 220.

The CPU 200 controls the display unit 21 to switch between display of an image of image data previously stored in the ROM 201 and an image of display image data input from the CPU 100 via the IF unit 26. The CPU 200 calculates the coordinates of a touch position on the touch panel 22 based on coordinate data input from the touch panel control unit 220 to output an electric signal corresponding to a calculation result of the coordinates of the touch position as a signal corresponding to the touch position to the CPU 100 via the IF unit 26. When a user operation on the touch panel 22 is disabled, the CPU 200 does not output an electric signal corresponding to a calculation result of the coordinates of a touch position.

The CPU 200 performs the retraction display unit control processing and the exposure display unit control processing, both of which will be described below.

The ROM 201 stores various kinds of programs, such as the control programs related to control of the operation panel 2, and information and data on connection with the image forming apparatus 1. The information on connection is information indicating establishment of the connection to the image forming apparatus 1, information acquired from the image forming apparatus 1, and the like. Examples of the information acquired from the image forming apparatus 1 include information about a state of the image forming apparatus 1, such as the standby mode, the sleep mode, or an error detection, and count information, such as the number of copies.

The RAM 202 is used as a working area in calculation performed by the CPU 200, and temporarily stores data.

The timer 203 performs timekeeping and counts count values under the control of the CPU 200 while the CPU 200 performs various kinds of processing.

The display unit 21 is a liquid crystal panel or the like for displaying an image of image data previously stored in the ROM 201 or an image of display image data input from the control unit 10 via the IF unit 26 under the control of the panel control unit 20. The image displayed on the display unit 21 is an image of information about image formation, such as the number of copies and the size of the sheet S on which an image is to be formed, an image of input keys to configure settings about reading an image, such as the size of a document, or the like.

As described above, the display unit 21 displays a predetermined image by switching between an image of image data stored in the ROM 201 of the operation panel 2 and an image of display image data received by the operation panel 2 from the control unit 10 under the control of the CPU 200. The display unit 21 can change the luminance of its backlight under the control of the CPU 100.

The touch panel 22 is superimposed on the display unit 21, and causes a screen of the display unit 21 to be visible through the touch panel 22. The touch panel 22 is connected to the panel control unit 20 via the touch panel control unit 220. The touch panel 22 detects touch operations by the user on images displayed on the display unit 21 to output electric signals corresponding to the detection results to the touch panel control unit 220.

The operation sound generation unit 23 generates operation sounds corresponding to operations on the touch panel 22 under the control of the panel control unit 20.

The state display unit 24 is a light-emitting diode (LED) or the like for notifying the user of a state of the image forming apparatus 1. The state display unit 24 is turned on or off based on a state of the image forming apparatus 1, and changes the light emission state under the control of the CPU 200. The state of the image forming apparatus 1 is a state where a job is being executed, an error, such as a jam and a sheet shortage, is occurring, a component failure is suspected, a cover of the image forming apparatus 1 is opened, or the like. For example, when a jam occurs in the apparatus main body la during sheet feeding and the conveyance of the sheets S is stopped, the state display unit 24 notifies the user of the state by blinking or lighting.

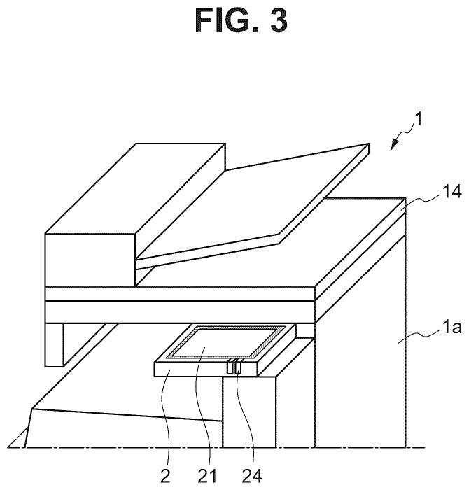

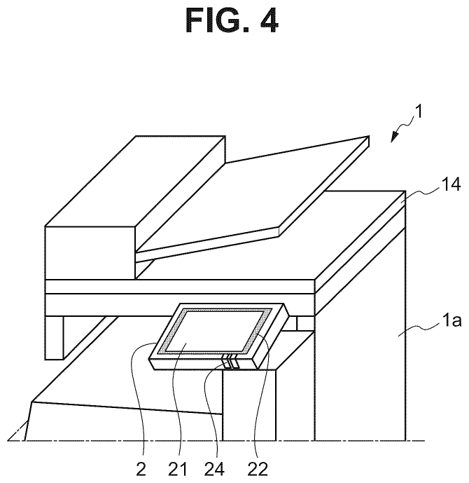

The key input unit 25 is provided at a position of the operation panel 2 other than the position where the display unit 21 is disposed, and includes hardware keys, such as a key for starting a job of the image forming apparatus 1, numeric keypads for entering numerical values, and a key for instructing switching to the sleep mode. The key input unit 25 receives settings of the image forming apparatus 1 or inputs of job commands from the user via the key or the numeric keypads to output electric signals corresponding to the received inputs to the panel control unit 20. In the operation panel 2 illustrated in FIGS. 3 and 4, the key input unit 25 is not illustrated.

The IF unit 26 connects the CPU 100 of the control unit 10 and the CPU 200 of the panel control unit 20.

The touch panel control unit 220 operates under the control of the panel control unit 20. The touch panel control unit 220 detects the position of a touch by the user on the touch panel 22 based on the electric signal input from the touch panel 22 to output coordinate data on the detected touch position to the CPU 200.

The operation panel 2 may include a state sound generation unit, such as a speaker that emits sound or voice, corresponding to a state of the image forming apparatus 1, in addition to or in place of the state display unit 24. The operation panel 2 includes both the display unit 21 and the touch panel 22. However, the operation panel 2 is not limited thereto, and may include a touch panel display serving as a display unit that has the functions of both the display unit 21 and the touch panel 22. In this case, the touch panel display receives touch operations by the user. In the touch operation on the touch panel display, the CPU 200 calculates the coordinates corresponding to the position of a touch by the user on the surface of the touch panel display to output an electric signal based on the calculated coordinates.

In the operation panel 2 having the above-described configuration, the user can touch the input unit or the button keys displayed on the display unit 21 via the touch panel 22 by a finger to perform inputs and the like. Thus, the user can configure settings about an image formation, for example, the number of copies and the size of the sheet S, or settings about reading an image, for example, the size of a document.

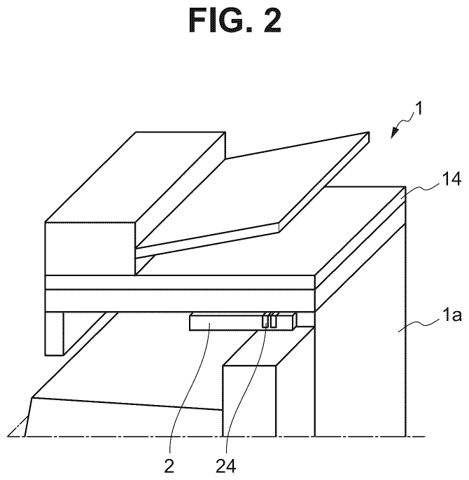

The operation panel 2 is extendable from/withdrawable into the apparatus main body la. The operation panel 2 is movable between a retracted position, as a retracted state illustrated in FIG. 2, and an exposed position, as an exposed state illustrated in FIG. 3. As illustrated in FIG. 4, the operation panel 2 is pivotable with respect to the pivot shaft parallel to the X direction, with the pivot shaft providing a pivot center in the exposed state.

The exposed position as the exposed state is a first position where the display unit 21, the touch panel 22, and the key input unit 25 are each exposed entirely from, i.e. not hidden by, the apparatus main body la. The retracted position as the retracted state is a second position where at least a part of the display unit 21 and the touch panel 22 is retracted inside the apparatus main body la and is not visible from the outside. The retracted position includes a third position where the entire display unit 21 and the entire touch panel 22 are each retracted inside the apparatus main body la, so as not to be visible from the outside.

In the exposed state where the operation panel 2 is at the exposed position, the entire display unit 21 is visible from the outside. Further, in the exposed state where the operation panel 2 is at the exposed position, the entire touch panel 22 is in a state where the user can perform operations, such as a touch operation, and the entire key input unit 25 is in a state where the user can perform operations, such as key pressing.

In the retracted state where the operation panel 2 is at the retracted position, at least a part of the display unit 21 is not visible from the outside, with at least another part of the display unit 21 being visible from the outside. Further, in the retracted state where the operation panel 2 is at the retracted position, at least a part of the touch panel 22 is not operable by the user.

When the operation panel 2 is at the exposed position, the operation panel 2 operates based on a touch operation on the touch panel 22, whereas when the operation panel 2 is at the retracted position, the operation panel 2 does not operate based on a touch operation on the touch panel 22.

When the operation panel 2 is at the exposed position, the CPU 200 controls the luminance of the display unit 21 to a first luminance. When the operation panel 2 is at the retracted position, the CPU 200 controls the luminance of the display unit 21 to a second luminance lower than the first luminance. Further, when the operation panel 2 is at the third position, the CPU 200 controls the luminance of the display unit 21 to a third luminance lower than the second luminance. The second luminance and the third luminance of the display unit 21 include turning off the display unit 21.

### Operation of Image Forming Apparatus

Operation of the image forming apparatus 1 according to the present exemplary embodiment will now be described in detail with reference to FIGS. 1 to 5.

When an image forming job is input from the touch panel 22 of the operation panel 2, the control unit 10 receives the image forming job from the touch panel 22 via the touch panel control unit 220, the panel control unit 20, and the IF unit 26 to start the image forming operation.

When the image forming operation is started, the sheet S stored in either the sheet cassette 19A or the sheet cassette 19B is conveyed to the secondary transfer portion formed by the intermediate transfer belt 155 and the secondary transfer roller 156.

At that time, in the image forming unit 15, the surface of the photosensitive drum 150Y is charged by the charging device 151Y.

The laser scanner unit 154 then emits a laser beam to the surface of the photosensitive drum 150Y based on the image data on a document read by the reader 14 or the image data received from the external device via a network. As a result, an electrostatic latent image is formed on the surface of the photosensitive drum 150Y.

The developing device 152Y applies yellow toner to the electrostatic latent image formed on the surface of the photosensitive drum 150Y to form a yellow toner image on the surface of the photosensitive drum 150Y.

The toner image formed on the surface of the photosensitive drum 150Y is primarily transferred to the intermediate transfer belt 155 by the primary transfer roller 153Y.

In similar manner, a magenta toner image, a cyan toner image, and a black toner image are respectively formed on the photosensitive drums 150M, 150C, and 150K. When primary transfer biases are applied to the primary transfer rollers 153M, 153C, and 153K, these toner images are transferred and superimposed on the yellow toner image on the intermediate transfer belt 155. As a result, a full-color toner image based on the image signal is formed on the surface of the intermediate transfer belt 155.

The full-color toner image formed on the intermediate transfer belt 155 is conveyed to the secondary transfer portion by rotation of the intermediate transfer belt 155.

The full-color toner image on the intermediate transfer belt 155 conveyed to the secondary transfer portion is transferred to the sheet S fed from the sheet cassette 19A or the sheet cassette 19B at the secondary transfer portion.

The sheet S with the toner image transferred thereon is conveyed to the fixing unit 13, and the toner image is fixed by the heating processing and the pressurization processing at the fixing unit 13.

The sheet S with the toner image fixed thereto is then conveyed to the processing apparatus 16. When the user specifies processing, such as stapling, punching, and binding, the sheet S conveyed to the processing apparatus 16 is subjected to the specified processing, and is then discharged to the discharge tray 161a. When the user does not specify processing or the processing apparatus 16 is not connected to the control unit 10, the sheet S with the toner image fixed thereto is discharged to the discharge tray 161b as it is.

### Mode Transition Operation of Image Forming Apparatus

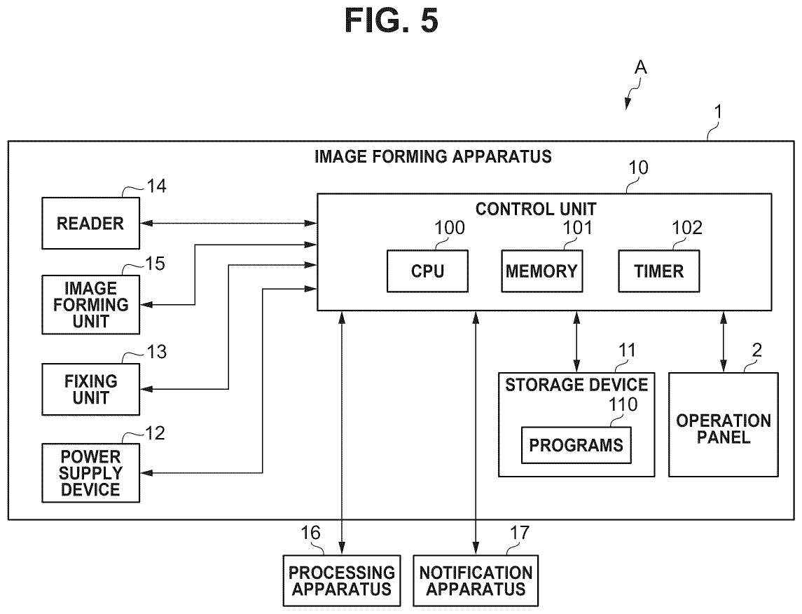

The mode switching operation of the image forming apparatus 1 according to the present exemplary embodiment will now be described in detail with reference to FIG. 5.

The CPU 100 can perform the mode switching operation for switching to the standby mode as a first power mode in which an image can be formed on the sheet S to the sleep mode as a second power mode with less power consumption than that of the standby mode.

In the standby mode, based on the control of the CPU 100, the power supply device 12 supplies power to the control unit 10 and the devices to be used, and does not supply power to the devices for use. For example, when the user selects a reading of an image, the power supply device 12 supplies power to the reader 14 that is a device to be used, but does not supply power to the image forming unit 15 and the processing apparatus 16 that are devices not to be used based on the control of the CPU 100.

In the standby mode of the image forming apparatus 1 with the operation panel 2 at the exposed position, when a predetermined time as a second time elapses, the CPU 100 performs the mode switching operation for switching the mode of the image forming apparatus 1 to the sleep mode. When a switching instruction to the sleep mode is received from the user via the touch panel 22, the CPU 100 performs the mode switching operation to switch from the standby mode to the sleep mode. The CPU 100 performs the mode switching operation for switching the mode to the sleep mode in the retraction display unit control processing, as described below.

In switching from the standby mode to the sleep mode, the power supply device 12 stops the supply of the power to the devices in the standby mode based on the control of the CPU 100.

When detecting an input by the user in the sleep mode, the CPU 100 performs the mode switching operation for returning from the sleep mode to the standby mode. For example, when the CPU 100 receives the input of a return instruction from the sleep mode to the standby mode by the user via the touch panel 22 in the sleep mode, the CPU 100 performs the mode switching operation for returning from the sleep mode to the standby mode.

In the sleep mode, when input is received of a detection result indicating the placement of a document on the reader 14 from the reader 14, the CPU 100 performs the mode switching operation for returning from the sleep mode to the standby mode. The CPU 100 performs the mode switching operation for switching the mode of the image forming apparatus 1 to the standby mode in the exposure display unit control processing, as described below.

### Method of Detecting State of Operation Panel

A method of detecting a state of the operation panel 2 of the image forming apparatus 1 according to the present exemplary embodiment will now be described in detail with reference to FIGS. 2 to 4, and FIGS. 7A to 7C.

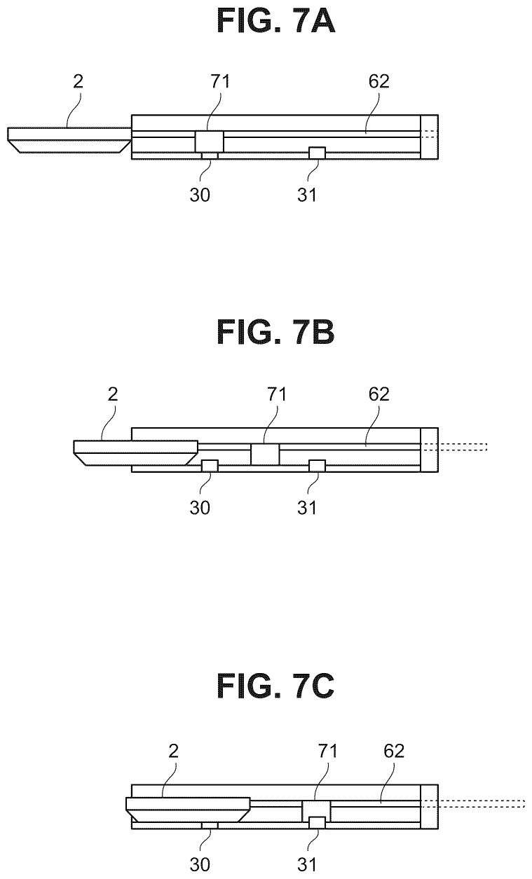

FIG. 7A illustrates the exposure state where the operation panel 2 is at the exposed position. FIG. 7B illustrates an intermediate state where the operation panel 2 is at an intermediate position between the exposure position and the retracted position (referred to as the intermediate position). FIG. 7C illustrates the retracted state where the operation panel 2 is at the retracted position.

In FIGS. 7A to 7C, the light emission units and the light reception units of the first detection sensor 30 and the second detection sensor 31 are each disposed at an interval along a direction of movement of operation panel 2, orthogonal to the direction of movement illustrated in FIGS. 7A to 7C (i.e., the Y direction, i.e., a depth direction). The light shielding member 71 passes through a space between the light emission unit and the light reception unit of the first detection sensor 30, and a space between the light emission unit and the light reception unit of the second detection sensor 31. The operation panel 2 may have a concave portion and the like that cause the light emitted from the light emission unit of the first detection sensor 30 to reach the light reception unit of the first detection sensor 30 without blocking the light, in the state illustrated in FIG. 7C.

When the operation panel 2 is in the exposed state (i.e., the state illustrated in FIG. 3), the light emitted from the light emission unit of the first detection sensor 30 is blocked by the light shielding member 71 as illustrated in FIG. 7A, and thus the first detection sensor 30 detects the light shielding member 71. Further, when the operation panel 2 is in the exposed state, the light emitted from the light emission unit of the second detection sensor 31 is received by the light reception unit of the second detection sensor 31 without being blocked by the light shielding member 71 as illustrated in FIG. 7A, and thus the second detection sensor 31 does not detect the light shielding member 71. In this case, the CPU 100 determines from the detection results of the first detection sensor 30 and the second detection sensor 31 that the operation panel 2 is in the exposed state.

When the operation panel 2 is in the intermediate state, the light emitted from the light emission unit of the first detection sensor 30 is received by the light reception unit of the first detection sensor 30 without being blocked by the light shielding member 71 as illustrated in FIG. 7B, and thus the first detection sensor 30 does not detect the light shielding member 71. When the operation panel 2 is in the intermediate state, the light emitted from the light emission unit of the second detection sensor 31 is received by the light reception unit of the second detection sensor 31 without being blocked by the light shielding member 71 as illustrated in FIG. 7B, and thus the second detection sensor 31 does not detect the light shielding member 71. In this case, the CPU 100 determines from the detection results of the first detection sensor 30 and the second detection sensor 31 that the operation panel 2 is in the intermediate state.

When the operation panel 2 is in the retracted state (i.e., the state illustrated in FIG. 2), the light emitted from the light emission unit of the first detection sensor 30 is received by the light reception unit of the first detection sensor 30 without being blocked by the light shielding member 71 as illustrated in FIG. 7C, and thus the first detection sensor 30 does not detect the light shielding member 71. Further, the light emitted from the light emission unit of the second detection sensor 31 is blocked by the light shielding member 71 as illustrated in FIG. 7C, and thus the second detection sensor 31 detects the light shielding member 71. In this case, the CPU 100 determines from the detection results of the first detection sensor 30 and the second detection sensor 31 that the operation panel 2 is in the retracted state.

A stopper and the like may be provided to prevent movement of the operation panel 2 in the depth direction (i.e., the right direction in FIG. 7C) beyond the retracted position illustrated in FIG. 7C.

The first detection sensor 30 and the second detection sensor 31 are not limited to the photo sensors, and may be mechanical sensors, such as switches. Further, a detection and a non-detection of the light shielding member 71 using the first detection sensor 30 and the second detection sensor 31 can be the reverse of the method described above.

### Panel State Detection Processing

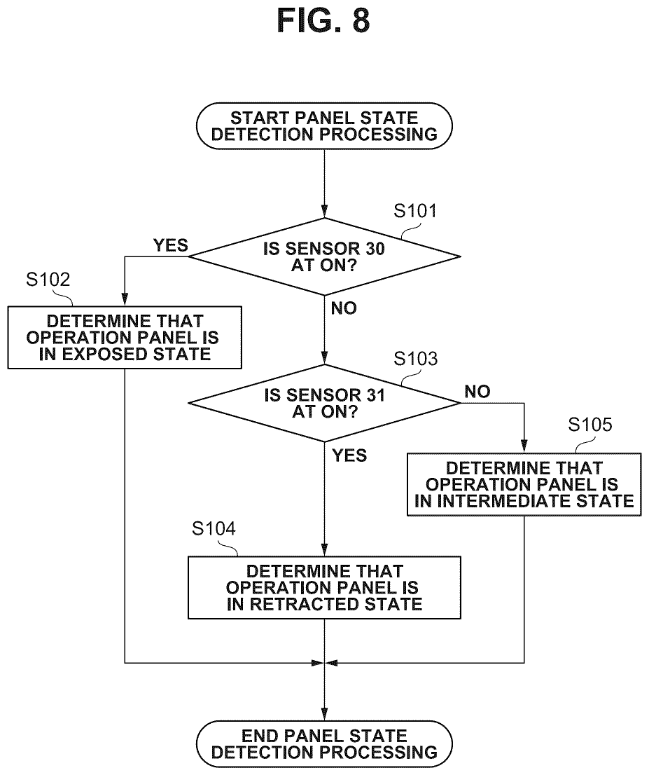

The panel state detection processing performed by the image forming apparatus 1 according to the present exemplary embodiment will now be described in detail with reference to FIG. 8.

FIG. 8 is a diagram illustrating the panel state detection processing of detecting a state of the operation panel 2. The panel state detection processing starts when the main power supply of the image forming apparatus 1 is turned on. Unless otherwise indicated, in FIG. 8, a detection of the light shielding member 71 using the first detection sensor 30 and the second detection sensor 31 is ON.

In step S101, the CPU 100 determines a detection state of the light shielding member 71 using the first detection sensor 30 based on the electric signal input from the first detection sensor 30. In this manner, it is determined whether the first detection sensor 30 detects the light shielding member 71 (i.e., whether the first detection sensor 30 is ON).

If the first detection sensor 30 detects the light shielding member 71 (YES in step S101), the processing proceeds to step S102. In step S102, the CPU 100 determines that the operation panel 2 is in the exposed state. The CPU 100 performs control for the case where the operation panel 2 is in the exposed state, and the panel state detection processing then ends. At this time, the CPU 100 outputs an electric signal indicating that the operation panel 2 is in the exposed state to the operation panel 2. In this manner, the CPU 100 notifies the CPU 200 of the operation panel 2 that the operation panel 2 is in the exposed state.

If the first detection sensor 30 does not detect the light shielding member 71 (NO in step S101), the processing proceeds to step S103. In step S103, the CPU 100 determines a detection state of the light shielding member 71 based on the electric signal input from the second detection sensor 31. In this manner, it is determined whether the second detection sensor 31 detects the light shielding member 71 (i.e., whether the second detection sensor 31 is at ON).

If the second detection sensor 31 detects the light shielding member 71 (YES in step S103), the processing proceeds to step S104. In step S104, the CPU 100 determines that the operation panel 2 is in the retracted state. The CPU 100 performs control for the case where the operation panel 2 is in the retracted state, and the panel state detection processing then ends. At this time, the CPU 100 outputs an electric signal indicating that the operation panel 2 is in the retracted state to the operation panel 2. In this manner, the CPU 100 notifies the CPU 200 of the operation panel 2 that the operation panel 2 is in the retracted state.

If the second detection sensor 31 does not detect the light shielding member 71 (NO in step S103), the processing proceeds to step S105. In step S105, the CPU 100 determines that the operation panel 2 is in the intermediate state. The CPU 100 performs control for the case where the operation panel 2 is in the intermediate state, and the panel state detection processing then ends. At this time, the CPU 100 outputs an electric signal indicating that the operation panel 2 is in the intermediate state to the operation panel 2. In this manner, the CPU 100 notifies the CPU 200 of the operation panel 2 that the operation panel 2 is in the intermediate state.

The CPU 100 controls the operation of the operation panel 2 based on the state of the operation panel 2 determined by the above-described panel state detection processing. When the operation panel 2 is at the exposed position, the CPU 100 controls the operation of the operation panel 2 based on an electric signal corresponding to a calculation result of the coordinates of a touch position on the touch panel 22 input from the operation panel 2. When the operation panel 2 is at the retracted position, the CPU 100 does not control the operation of the operation panel 2.

In addition, the CPU 200 outputs an electric signal corresponding to a calculation result of the coordinates of a touch position on the touch panel 22 based on the state of the operation panel 2 determined by the above-described panel state detection processing. When the operation panel 2 is at the exposed position, the CPU 200 outputs an electric signal corresponding to a calculation result of the coordinate of a touch position. When the operation panel 2 is at the retracted position, the CPU 200 does not output an electric signal corresponding to a calculation result of the coordinates of a touch position. The CPU 200 may output an electric signal corresponding to a calculation result of the coordinates of a touch position irrespective of a position of the operation panel 2.

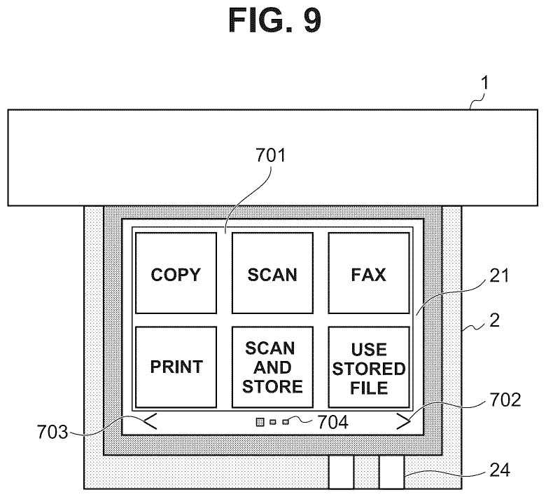

FIG. 9 is a diagram illustrating an example of the display unit 21 when the operation panel 2 is in the exposed state.

In the present exemplary embodiment, the display unit 21 can display a list of operation keys 701 in a form of icons for performing predetermined operations related to an image formation. Examples of functions displayed as the operation keys 701 include a copy function, a scan function, and a facsimile (FAX) function. In this case, the operation keys 701 correspond to a first operation key portion.

Depending on the number of functions implemented in the image forming apparatus 1, all of the operation keys 701 may not be able to be displayed in one screen, and the operation keys 701 are displayed on a plurality of screens in some cases. An operation key 702 and an operation key 703 are used to switch between the plurality of screens. The user's operation of the operation key 702 and the operation key 703 allows the user to switch between the plurality of screens. In this case of the first state, the operation key 702 and the operation key 703 correspond to a first selection key. The plurality of screens displayed when the operation panel 2 is in the exposed state corresponds to a plurality of first screens.

An operation key 704 indicates the number of the plurality of screens. In the present exemplary embodiment, the number of switchable screens is displayed as the number of points of the display key 704, and the screen currently being displayed is indicated by changing the size of the corresponding point of the display key 704. In the example provided in FIG. 9, the number of points is three, with the left-most point corresponding to the screen that is currently being displayed. The user's operation of the operation key 702 and the operation key 703 or performing a flick operation to the left and right on the touch panel 22 allows the user to switch between the display screens.

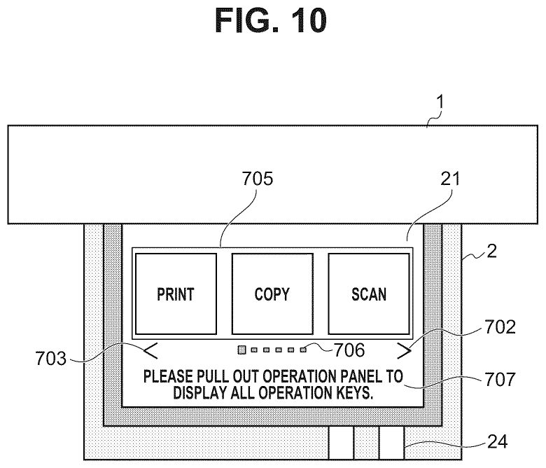

FIG. 10 is a diagram illustrating an example of the display unit 21 when the operation panel 2 is in the intermediate state. Operation keys 705 are icons for performing predetermined operations related to an image formation. In this case, the operation keys 705 correspond to a second operation key portion. In the intermediate state, the area of the display unit 21 exposed to the outside is smaller than that of the exposed state illustrated in FIG. 7A. Thus, the amount of information displayed on a single screen of the display unit 21 may be smaller than that of the exposed state. Reducing the size of the icons of the operation keys 705 can increase the number of operable keys, but operability may be degraded. Thus, in the present exemplary embodiment, the number of operation keys 705 in the intermediate state is reduced from the number of operation keys 701 in the exposed state. When all of the operation keys 705 cannot be displayed on a single screen in the intermediate state, the operation keys 705 are displayed on a plurality of screens. In this case, the plurality of screens is switched using the operation key 702 and the operation key 703. An operation key 706 in FIG. 10 has the same function as that of the operation key 704 in FIG. 9. In the intermediate state of FIG. 10, the operation key 702 and the operation key 703 correspond to a second selection key. The plurality of screens displayed when the operation panel 2 is in the intermediate state corresponds to a second plurality of screens.

As described above, in the intermediate state, the number of operation keys 705 displayed is less than that of the exposed state. Thus, all of the functions are displayed by increasing the number of screens to be switched between, compared with the number of screens in the exposed state. In this case, the number of points displayed using the operation key 706 is greater than that of the exposed state.

An arrangement of the icons displayed in the operation keys 701 and the operation keys 705 can be set by the user. The icons can be rearranged based on the frequency of use of the functions corresponding to the icons.

The user may unintentionally leave the operation panel 2 in the intermediate state. In this case, the display area of the display unit 21 is smaller than that of the exposed state, which may reduce the visibility of the display unit 21. This can lead to decrease in usability. Thus, in the present exemplary embodiment, the display unit 21 shows a prompt 707 for the user to pull the operation panel 2, to move to the exposed state from the intermediate state. In other words, the prompt 707 informs the user to pull the operation panel 2.

The prompt 707 illustrated in FIG. 10 is an example of a display for informing the user to pull the operation panel 2. In the present exemplary embodiment, the prompt 707 is a message for instructing prompting he user to pull the operation panel 2. When recognizing the information on the prompt 707, the user becomes aware that the operation panel 2 is in the intermediate state, and that the display area of the display unit 21 is smaller than that of the exposed state. The user also becomes aware that the display area of the display unit 21 can be increased by pulling the operation panel 2 to increase the exposed display area for the operation keys 705 to occupy. In the present exemplary embodiment, as an arrangement example of the prompt 707, the prompt 707 is arranged below the operation key 702 and the operation key 703 in vertical directions of the display unit 21. This arrangement of the prompt 707 provides a reliable notification to the user, even when an area of the operation panel 2 exposed to the outside is small.

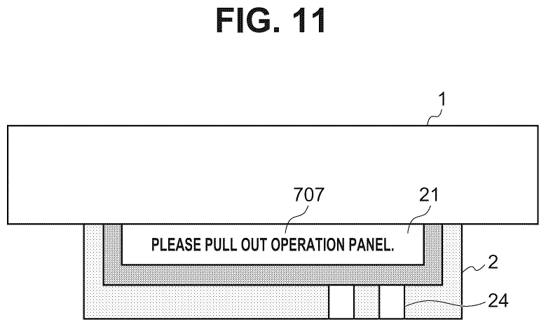

FIG. 11 is a diagram illustrating a state where the display area of the display unit 21 is reduced as compared with the case in FIG. 10. In FIG. 11, the display area is small and the operation keys 705 cannot be displayed. In such a case, the display unit 21 shows the prompt 707 instructing the user to pull the operation panel 2. As a result, the user becomes aware that it is necessary to pull the operation panel 2 in order to operate the operation panel 2. This can improve usability.

In the present exemplary embodiment, the prompt 707 can be in another form as long as the prompt 707 prompts the user to pull the operation panel 2. In other words, the prompt 707 is not limited to indicating a message, and a figure, such as an icon, an animation, or the like can be used as the prompt for the user to pull the operation panel 2.

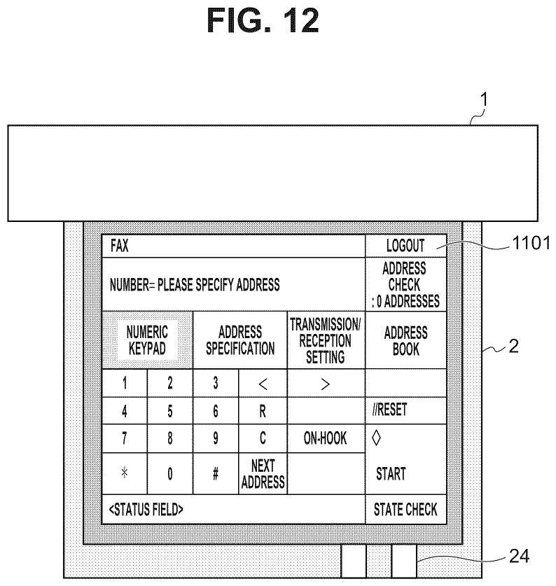

FIG. 12 illustrates an example of the display unit 21 that appears when a FAX key of the operation keys 701 is operated while the operation panel 2 is in the exposed state. In the present exemplary embodiment, when a predetermined key of the operation keys 701 is operated, the displayed screen transitions to a detailed operation screen corresponding to the operated key.

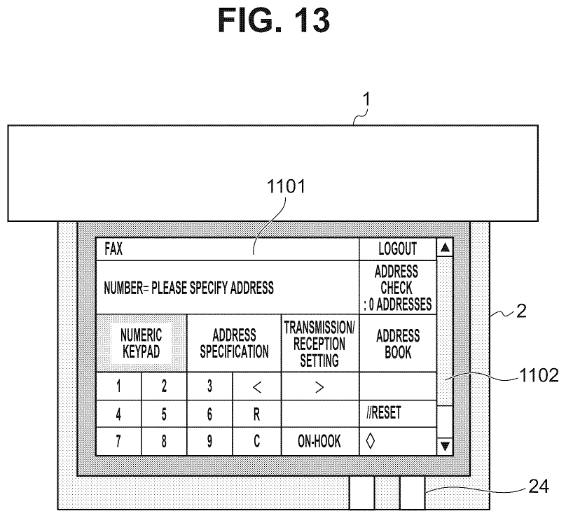

FIG. 13 illustrates an example of the display unit 21 that appears when a FAX key of the operation keys 701 is operated while the operation panel 2 is in the intermediate state. In FIG. 13, similar to FIG. 12, the displayed screen transitions to a detailed operation screen corresponding to the FAX key, but the display area of the display unit 21 is smaller than the case where the operation panel 2 is in the exposed state. Thus, in FIG. 13, a cursor 1102 is provided in the display area, and the display area can be changed by operating the cursor 1102. This configuration allows information to be sufficiently displayed in the detailed operation screen even when the display area of the display unit 21 is small.

The present disclosure is not limited to the above-described exemplary embodiment, and can be variously modified without departing from the spirit of the present disclosure.

According to the present disclosure, an image forming apparatus including an operation unit retractable into the storage portion can reduce possible decrease in usability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-112959, filed Jul. 12, 2024, which is hereby incorporated by reference herein in its entirety.

What is claimed is:

1. An image forming apparatus comprising:
an apparatus main body including an image forming unit configured to form an image on a recording medium; and
an operation unit including a display unit configured to display information about the image formation,
wherein the display unit is configured to receive a touch operation from a user,
wherein the operation unit is movable between a first position where the entire display unit is exposed to an outside of the apparatus main body, and a second position where at least a part of the display unit is retracted within the apparatus main body to reduce visibility of the at least a part of the display unit from the outside of the apparatus main body, and
wherein, in a case where the operation unit is at the second position, the display unit is configured to prompt the user to pull the operation unit from the apparatus main body.

2. The image forming apparatus according to claim 1,
wherein, in a case where the operation unit is at the first position, the display unit displays a first operation key portion including a plurality of keys for performing predetermined operations of the image forming apparatus, and
wherein, in the case where the operation unit is at the second position, the display unit displays a second operation key portion including a plurality of keys for performing predetermined operations of the image forming apparatus.

3. The image forming apparatus according to claim 2, wherein a number of keys of the plurality of keys included in the first operation key portion displayed on a single screen in the case where the operation unit is at the first position is greater than a number of keys of the plurality of keys included in the second operation key portion displayed on a single screen in the case where the operation unit is at the second position.

4. The image forming apparatus according to claim 2,
wherein the first operation key portion is displayed on a plurality of first screens in the display unit, and
wherein the second operation key portion is displayed on a plurality of second screens in the display unit.

5. The image forming apparatus according to claim 4, wherein the display unit displays a first selection key for selection of one of the plurality of first screens displaying the first operation key portion, and displays a second selection key for selection of one of the plurality of second screens displaying the second operation key portion.

6. The image forming apparatus according to claim 5, wherein the prompt for the user to pull the operation unit from the apparatus main body is displayed below the second selection key displayed of the display unit.

7. The image forming apparatus according to claim 6, wherein the display unit includes a touch panel, and
wherein, when the display unit is retracted within the apparatus main body, the touch panel does not operate.
